(19) United States
(12) Patent Application Publication
(10) Pub. No.: US 2015/0176818 A1
(43) Pub. Date: Jun. 25, 2015

(54) WALL OR CEILING FITTED HOUSINGS

(71) Applicant: Glashütte Limburg Leuchten GmbH + Co. KG, Limburg (DE)

(72) Inventors: Tobias TRÄGER, Werl (DE); Thomas SCHNEIDER, Runkel (DE); Jan MISCHKOWSKI, Limburg (DE); Holger KLIMMEK, Hunfelden (DE); Ulrich HÜPPER, Limburg (DE)

(21) Appl. No.: 14/577,928

(22) Filed: Dec. 19, 2014

(30) Foreign Application Priority Data
Dec. 23, 2013 (EP) 13006048.6

(51) Int. Cl. F21V 17/12

(52) U.S. Cl. CPC F21V 17/12

(57) ABSTRACT

Ceiling or wall fitted housings for illuminant integration comprise a base element, a wall element linked to the base element, as well as a supporting element that is installed opposite to the base element and that extends from the wall element in the side that faces away from the base element, whereby the wall element has a thread at least on its inside. The thread is directly pressed into the wall element of the fitted housing from the outside as a beading and extends as a bulge in the inner side of the wall.

### CROSS-REFERENCE TO RELATED APPLICATION

This application claims priority to foreign European patent application No. EP 13006048.6, filed on Dec. 23, 2013, the disclosure of which is incorporated by reference in its entirety.

### FIELD OF THE INVENTION

The present invention concerns a ceiling or wall fitted housing of an illuminant, containing a base element, a wall element linked to the base element, as well as a supporting element that is installed opposite to the base element and that extends from the wall element in the side that faces away from the base element, whereby the wall element has a thread at least on its inside.

### BACKGROUND

Ceiling- or wall-fitted housings of this type for installation in a suspended ceiling, a thin wall or also a concrete wall and/or concrete ceiling are known in a variety of designs. The ceiling or wall fitted housings are inserted in an appropriate slot of the wall and are meant to accommodate the illuminant in the housing so that the lamp is arranged directly on the ceiling and/or the wall. Then, the lamp is attached to the ceiling by means of two or several fastening elements that are arranged evenly on the circumference of the housing. Subsequently, the fitted housing is closed, on one hand to protect the illuminant and on the other hand for optical reasons, with a translucent cover, for example made of glass or plastics. The connection of the cover with the ceiling or wall fitted housing is usually ensured via a threaded connection, whereby the fitted housing is equipped with an internal thread in which a thread provided in the cover area can easily be screwed in.

Appropriate threads in the area of the fitted housing are inserted, based on the state of the art, for instance through machining of the component, for example through milling or turning. This machining process always requires an additional processing phase that does not only prolong the process but also causes additional costs. A disadvantage of machining is the material fatigue in the area of the thread and the occurrence of a structural separation. Furthermore, it became evident that additional processing steps were often necessary during machining, as machining does generally not lead to an even thread ready for immediate insertion. Rather, an accordingly manufactured thread still needs to be finished, e.g. deburred, in many cases. These additional processing steps lead to increased manufacturing costs and hence also to increased product costs.

Another approach of providing a thread in the fitted housing is the installation of a threaded insert. The threaded insert is an additional part that is manufactured separately from the actual fitted housing. This insert is then linked to the fitted housing through a form-fitting, force-fitting or bonded connection. This process also comes with significant additional costs and work, especially because both parts need to be accurately shaped whereby the prices of the fitted housing are increased considerably. Moreover, an additional safety aspect becomes important with regard to fitted housings that are manufactured accordingly, as the durability of the chosen linkage or connection between the fitted housing and the threaded insert must be guaranteed in order to avoid accidents.

Also, the use of sheet metal strips on the inside of the fitted housing, which are inserted as threads, turns out to be a problematic process in practice, as the even gradient of the thread and/or the thread sections provided by appropriate sheet metal strips cannot always be ensured. Such a thread is often technically insufficient and the manufacturing costs of the product increase as the respective threads need to be reworked.

### SUMMARY OF THE INVENTION

Therefore, the object of the invention is to provide a ceiling or wall fitted housing that can be equipped with an internal thread to accommodate a cover in a simple way.

This object is fulfilled through a ceiling or wall fitted housing whereby the thread is directly pressed into the wall element of the fitted housing from the outside as a beading and extends as a bulge in the inner side of the wall.

The present invention hence provides a simple, compact part, which can also be flexibly changed for the production of very small product lines as the denting process can be modified as needed through the use of already existing machines, and which is characterized by a cost-optimized manufacturing process. The thread can be manufactured in just a few production steps and in short manufacturing cycles. As the thread is shaped directly in the fitted housing, the material costs as well as the number of required processing steps can be reduced.

Thanks to the fully developed thread flanks, very good sliding and guiding properties can be achieved for the cover.

According a preferred embodiment, the wall element has a reduced wall thickness in the beading area. Through the formation of the beading, there is a material deformation that translates into a lower wall thickness whereby the flowability of the material is limited to the beading area so that the remaining wall element is not affected. The beading has in itself the same material thickness. Hence, evenly homogeneous wall thickness levels are achieved whereby warping of the entire fitted housing can be prevented.

According to another preferred embodiment, the beading extends once around the circumference of the wall element under a predefined gradient, i.e. the beading substantially performs a single spin around the wall element and ends after having completed approximately one spin of 360 degrees. Practical use has shown that an appropriately long beading is sufficient so that the thread of the cover can be firmly connected to the ceiling- or wall-fitted housing.

According to another embodiment, the beading is arranged in close proximity to the supporting element of the fitted housing. This ensures that the cover is connected to the fitted housing as firmly as possible.

According to another preferred embodiment, the fitted housing is made of metal, preferably aluminum or stainless steel. These materials have proven to be particularly suitable for the production of an appropriate housing since the housing can be manufactured simply by pressing or pulling, and/or because the material can be easily morphed and/or reshaped in a spinning lathe.

According to another preferred embodiment, the housing has a diameter of 50 to 600 mm, especially 70-450 mm. Consequently, the present invention also enables the insertion of threads in housings with different diameters.

Preferably, the fitted housing can form the luminaire housing, i.e. the housing itself absorbs the electrical components of the lamp and/or the complete luminaire fitting. Then, the lamp can be attached to the ceiling and/or the wall by means of the fastening elements on the outer circumference of the housing.

According to another object of the present invention, this concerns a manufacturing process of a ceiling- or wall-fitted housing, comprising the steps:
Manufacturing of a fitted housing, comprising a base element, a wall element that is linked to the base element, as well as a supporting element which is arranged on the side of the wall element that is opposite to the base element and that extends in the direction that faces away from the base element.
Formation of a thread on the internal wall of the fitted housing through denting of a beading from outside into the wall element with a predetermined radial spin and vertical gradient.

It becomes clear that the wall and/or ceiling fitted housings of the invention can be produced with a very small number of necessary procedural steps so that not only the material costs but also the manufacturing costs can be reduced. As the beading can be formed by means of a conventional sheet metal processing machine, it is possible to adapt the shape, e.g. the depth, width, etc., as well as the gradient of the beading without any major effort to the desired end product so that even small volumes can be manufactured in a cost-efficient way.

The fitted housing is preferably manufactured by means of the deformation process based on denting or pulling.

According to a preferred embodiment, the beading can be developed by performing a spin of 360 degrees and under a predefined gradient. In this context, a one-time extension of the beading around the circumference of the wall element has proven to be enough to ensure a sufficient fixing of the cover. The gradient can in this case be adjusted as desired so that the thread suits the thread that is predefined by the cover. The thread can be adapted to the respective glass thread in the wall element in a simple manner.

According to another preferred embodiment, the beading in the start and/or end sections is shown with a gradually increasing and/or decreasing depth, i.e. there is a start section in which the roll that dents the beading is at first retracted slowly over the wall element until the beading reaches its final depth. Equally, the roll is retracted slowly in the end section of the beading so that the beading levels off slowly. In this way, very narrow radii, which reinforce the warping tendency of the material in the area of the thread, can be avoided. In addition, a geometrically suitable thread, that accurately suits the thread of a cover or an insert, is produced.

According to another preferred object, the present invention provides a wall or ceiling lamp, including a wall- or ceiling-fitted housing as described above or produced according to the described process, an illuminant providing a source of light and a translucent cover and/or a translucent insert that is equipped with a thread on an external wall side which can be meshed with the thread on the internal wall of the wall- or ceiling-fitted housing.

Hence, the present invention provides a fitted housing with an integrated thread, which can be produced easily, cost-efficiently and with few materials or tools. A respective fitted housing can be used as a basic part for a variety of lamps in different installation scenarios.

### BRIEF DESCRIPTION OF THE DRAWINGS

In the following, the present invention is explained in greater detail on the basis of a preferred version example with reference to the drawings:

FIG. 1 a perspective view of a fitted housing with a shaped thread according to a version of the present invention,

FIG. 2 a cross-section through the housing from FIG. 1,

FIG. 3 a denting system for the production of the thread as a simplified scheme,

FIG. 4 an invention-based wall or ceiling lamp in accordance with a first version,

FIG. 5 a segment of the wall or ceiling lamp in the area of the thread,

FIG. 6 a wall or ceiling lamp according to another version of the present invention,

FIG. 7 a detail of the wall or ceiling lamp from FIG. 6,

FIG. 8 another wall or ceiling lamp according to a further, different version,

FIG. 9 a detail of the wall or ceiling lamp from FIG. 8,

FIG. 10 another wall or ceiling lamp according to a further, different version,

FIG. 11 a detail of the wall or ceiling lamp from FIG. 10,

FIG. 12 a wall or ceiling lamp according to a further version of the invention, and

FIG. 13 a ceiling lamp according to a further, different version of the invention.

### DETAILED DESCRIPTION

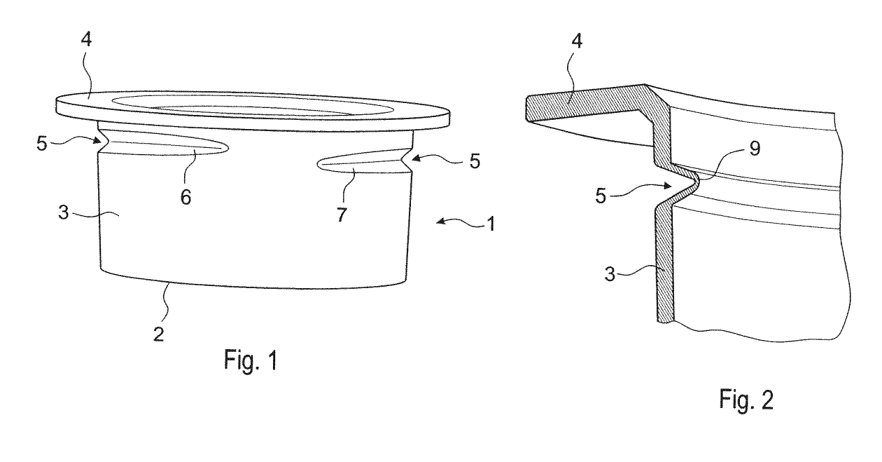

The fitted housing 1 shown in FIG. 1 substantially comprises a base 2, a wall element 3 that substantially extends vertically from the outer circumference of the base and to which a supporting element 4 is linked. The supporting element 4 is arranged on the side of the wall element 3 that is located opposite to the base 2 and extends from the wall element to the outside, e.g. in the direction that faces away from the base 2. During use, this supporting element is brought in contact with the ceiling and/or the wall for installation. Thereby, the supporting element 4 can be located on the inside or outside at the aperture in the wall and/or ceiling. The fitted housing is manufactured out of a single piece of metal, for example through the reshaping process denting.

A beading 5, i.e. a trough-shaped pit that substantially extends around the complete wall element into the external wall of the wall element 3, extends over the outer circumference of the housing 1, more precisely in the area of the wall element 3. It becomes clear that the beading is developed with a predefined gradient in the area of the external side of the wall element 3, so that the start of the beading and the end of the beading are arranged in a way as to offset one another in the direction of the height of the wall.

Moreover, it becomes clear that both the start section 6 and the end section 7 of the beading are shaped in a way as to gradually level off, i.e. the beading in this area does not reach its full depth but is developed with a slowly increasing and/or decreasing depth until the desired depth is achieved.

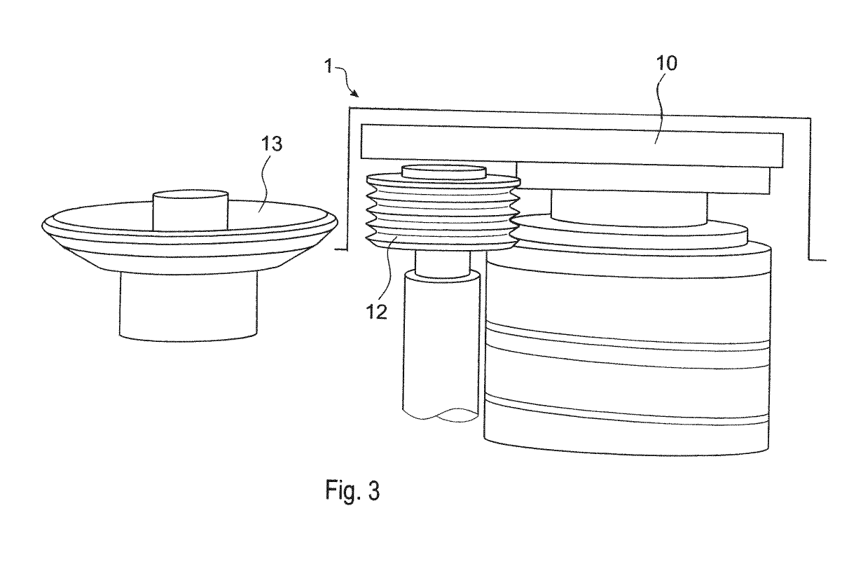

As shown in FIG. 2, the beading extends through the entire wall of the housing; a deformation of the material takes place here so that a bulge 9 is formed inside the housing on the inner side of the wall 8. This bulge 9 has at first a low, then an increasing height, in accordance with the increasing and/or decreasing depth of the beading. In addition, it becomes clear from FIG. 2 that the wall thickness in the area of the beading 5 and/or the bulge 9 is reduced, leading to the lowest wall thickness on the base of the beading and/or the highest point of the bulge. These different wall thickness levels are achieved through deformation of the wall element 3 during insertion of the beading.

By means of FIG. 3, the manufacturing process of an appropriate beading is briefly explained. Thereby, FIG. 3 schematically displays a tool to manufacture the beading, including an input section 10, a counter-roll 12 as well as a main roll 13. Besides, the fitted housing 1 is schematically indicated for better understanding.

Thereby, the previously manufactured denting part made of aluminum is first placed in an input section 10 through which the denting part is fastened vertically and radially. To fasten the denting part, a hold-down clamp moves downward from above to fasten the denting part horizontally. This prevents the denting part from moving during the reshaping process so that the deformation process can be implemented with constant characteristics.

The denting part is supported with the base 2 by the input section 10 so that the wall element 3 extends downwards. In the area of the inner side of the wall of the fitted housing, i.e. below the input section 10, a counter-roll 12 is installed which can be freely moved in a vertical direction and which stands in its resting position due to gravity. The edge of the counter-roll 12 accurately adjusts to the inner edge of the housing. The bearing of the counter-roll is attached to a boom, which, in turn, is connected to a processing unit on which the main roll is located (not shown). During operation, the main roll 13 presses onto the wall of the denting part from the outside.

Below the counter-roll 12 there is a link disc, which is firmly arranged on a spindle of the device. During the shaping of the beading, the link disc presses from below and through rotation of the spindle on the counter-roll 12 and pushes the latter upwards up to the end of the rotation and exactly by the degree of the desired thread pitch. After the end of the rotation, the counter-roll falls back down into its initial position due to its own weight.

During the formation of the beading, the housing 1 as described is first placed on the input section 10 of the spindle of the device and centrally fastened by a hold-down clamp. Thereby, slipping of the housing during the reshaping process is ruled out. The main roll 13 moves from the outside horizontally towards the housing 1 and is slowed down directly at the housing by means of a hydraulic deceleration unit. The spindle starts turning and the main roll gradually penetrates the material of the housing in an angle of approx. 15 degrees. In this process, the material of the wall element 3 is pressed into the counter-roll.

The link disc performs a 360° spin, whereby the counter-roll 12 is pressed upward during the spin and the main roll 13, which is freely mobile in its bearing in an axially upward direction, is carried along at the same time. It becomes clear that the main roll 13 is forcibly actuated by the material between the main roll 13 and the counter-roll 12. The profile between the main roll and the counter-roll is equivalent to the desired profile of the thread to be produced, i.e. of the beading.

After performing a spin of approx. 335°, the main roll 13 slowly starts to retract and returns to its initial position. This throttled penetration and retraction of the main roll from the material induces the beading to gradually start and to gradually level off, whereby small radii are prevented through which the warping tendency of the material in the area of the thread could be reinforced. In this process, a geometrically suitable thread, that matches the glass thread accurately, is produced.

After performing a spin of approx. 350°, the thread is finished and the spindle returns the remaining 10° to the initial position. Then, the hold-down clamp moves upwards and drives the counter-roll 12 into the resting position. The finished denting part with the developed thread beading can subsequently be taken out.

The fitted housing can, for example, be made of 3.0 mm aluminum material such as EN AW-1050A. The gradient can be influenced by the rotation of the link disc and the profile of the thread by the choice of the main roll and the counter-roll.

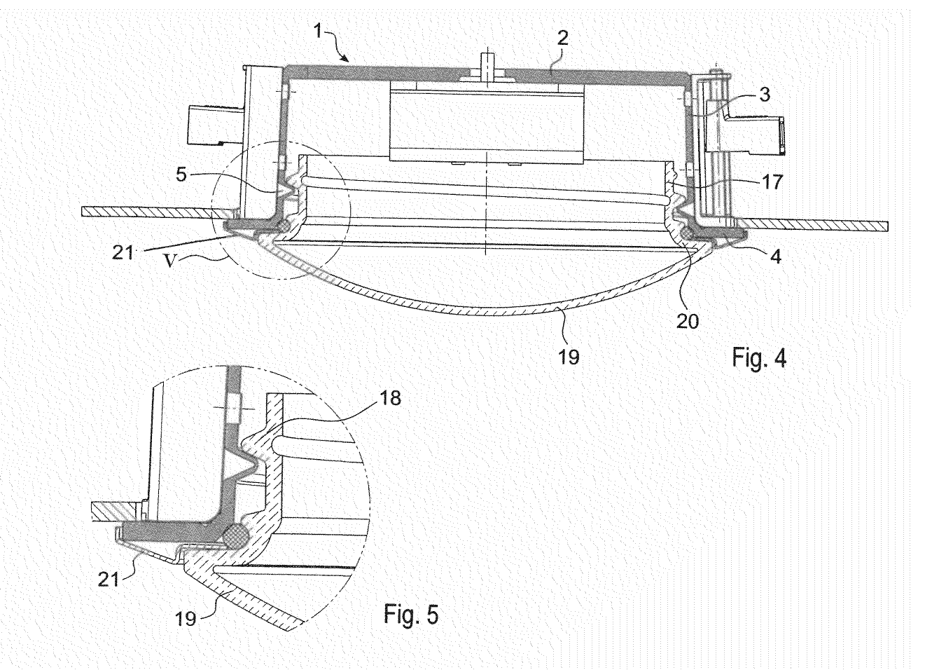

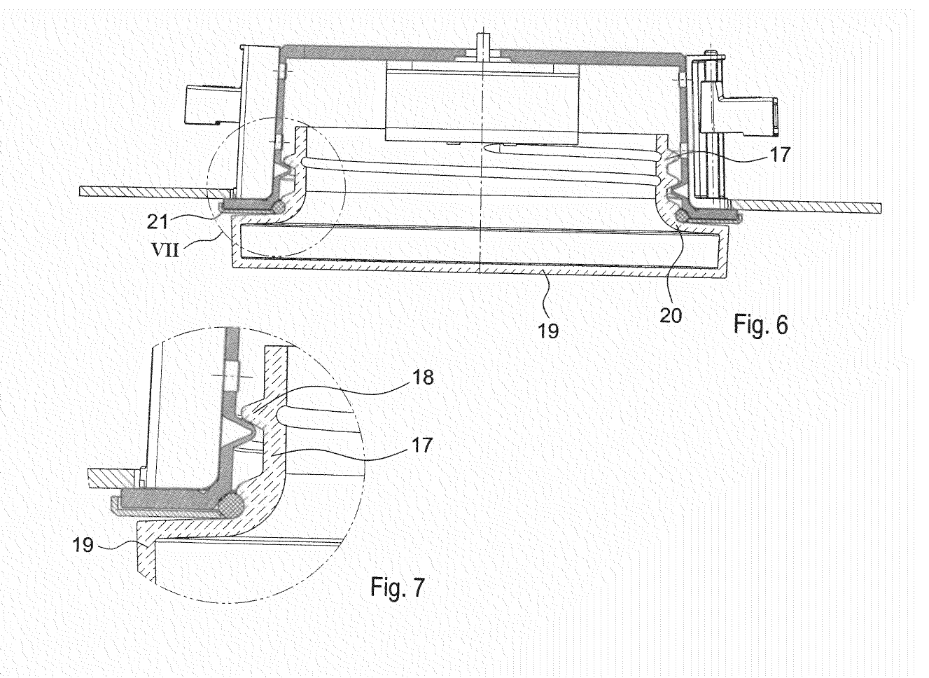

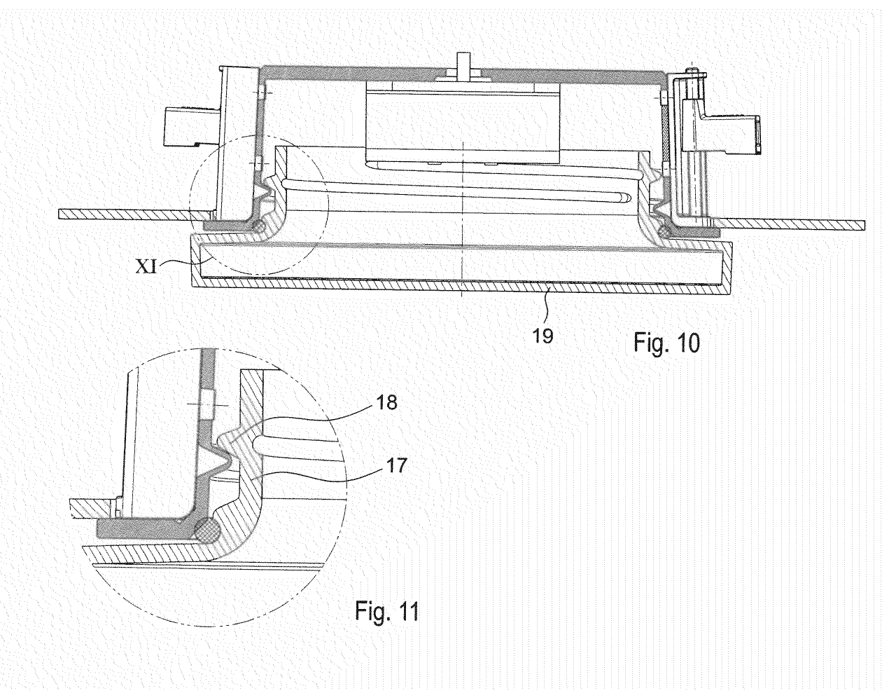

FIGS. 4 to 13 show finished fitted housings with illuminants fastened inside in an installed state, whereby the fitted housing is illustrated in the cross-section. The fitted housing 1 is closed with a translucent cover 19 in a finishing process. The individually displayed versions differ from each other with regard to the installation variants as well as the geometry of the cover 19. The cover 19 can be transparent, semi-transparent or even opaque. At the same time, a variety of geometrical shapes are possible, for example flat, curved, i.e. concave or convex, etc. FIGS. 4, 6 and 10 show a version in which the housing is flush-mounted in the ceiling so that the cover seemingly floats under the ceiling. Especially glass but also plastics have proven to be particularly suitable materials for the cover.

Hereby, FIGS. 5, 7, 9 and 11 show the thread and/or the linkage between the cover and the beading 5 of the fitted housing in an additionally magnified display. Regardless of the geometry visible from the outside, the cover has a tubular base 17, which is equipped with a glass thread 18 at the outer wall. Here, the glass thread 18 extends several times around the external circumference and is groove-shaped, i.e. the wall thickness is increased in the area of the glass thread 18. During use, the base 17 is inserted in the housing and the glass thread 18 encroaches the bulge 9 on the inside of the fitted housing to fasten the base in the fitted housing. As the glass thread 18 extends several times around the outer circumference, the cover element 19 can easily be screwed in up to the desired position.

As already illustrated, the cover element 19 can have several geometries, e.g. a straight or curved shape. In addition, differently shaped decorative rings 21 can be installed between the ceiling and/or the wall and the cover element in order to arrange the lamps in a different manner. Therefore, fastening is ensured by means of the respective glass thread.

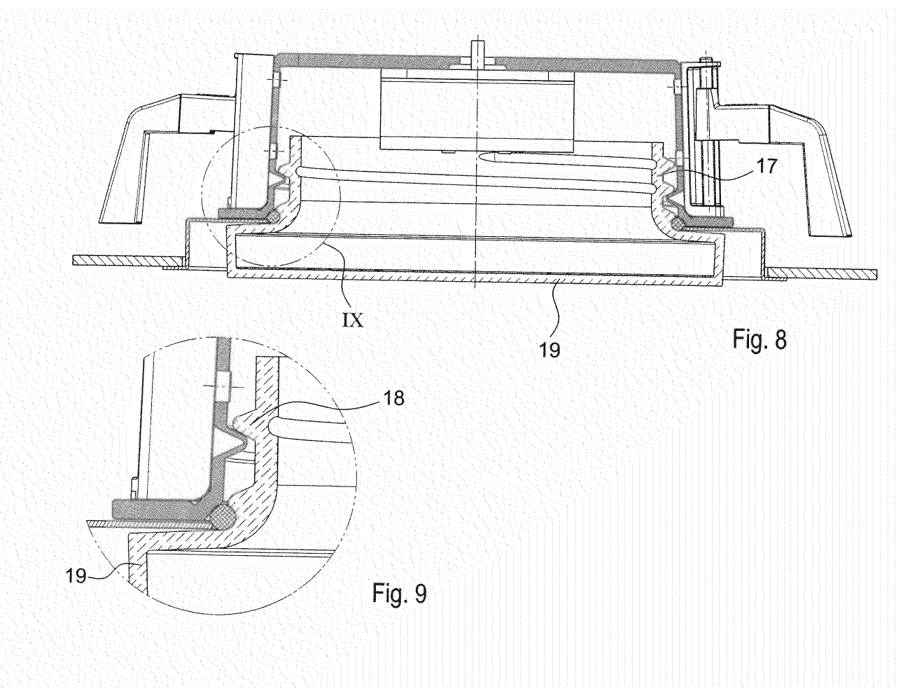

In the embodiment shown in FIG. 8, an additional ring is fastened on the lamp housing so that the cover element and the ceiling are aligned in one plane when installed.

In addition, a seal 20 can be provided with the fitted housing and the glass element in order to ensure dust-proof ends between the elements.

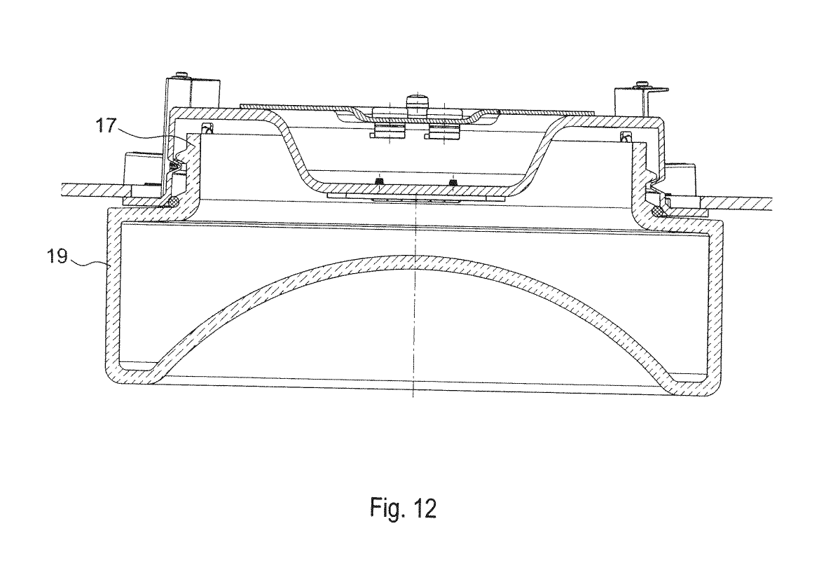

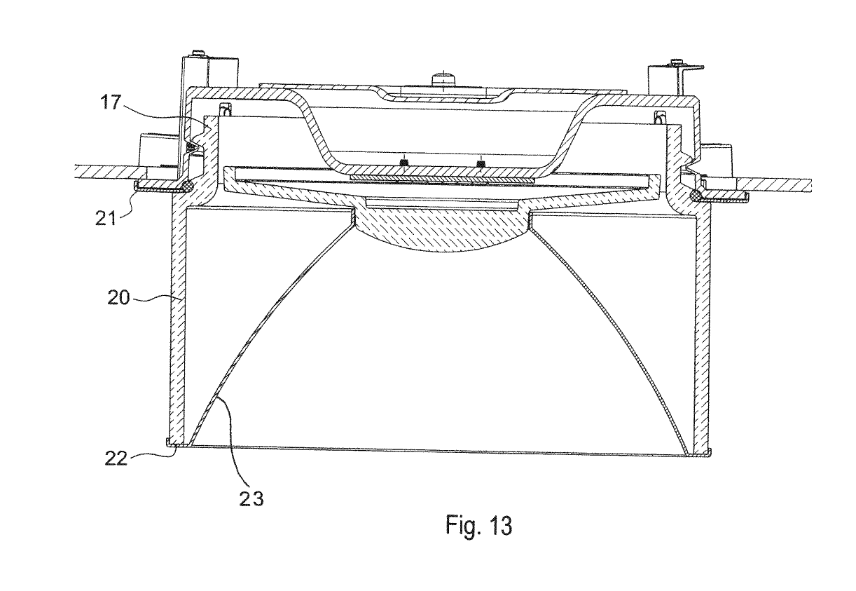

Two further embodiments of the invention are displayed in FIGS. 12 and 13. FIG. 12 hereby shows a combination of the fitted housing according to the invention with an inward curved cover 19. This example should demonstrate again the diverse design options of the cover 19.

In contrast to this, FIG. 13 shows an embodiment in which, instead of the cover, an insert 20 is connected to the fitted housings. Hereby, the insert 20 is substantially developed as a straight cylinder extending downwards, in which a reflector 23 is retained. Just as the cover 19, the insert 20 has a base equipped with a thread on its outside which encroaches the beading in the area of the fitted housing.

The reflector can extend up to the outer edge 22 of the insert 20 and encompass it.

The fitted housing integrates all electrical and mechanical components such as the source of light, power supply units, fastening elements and glasses. Since the fitted housing as herein described is equipped with a dented thread, the material thickness can be kept even and homogeneous. An equally high stability as well as good thermal properties can be ensured in this way.

1. A ceiling or wall fitted housing for illuminant integration, comprising:
a base element, a wall element linked to the base element, and a supporting element installed opposite to the base element and extending from the wall element in a side that faces away from the base element, whereby the wall element has a thread at least on its inside,
wherein the thread is pressed directly into the wall element of the fitted housing from the outside as a beading and extends as a bulge in the inner side of the wall.

2. The ceiling or wall fitted housing according to claim 1, wherein the wall element has a lower wall thickness in the area of the beading.

3. The ceiling or wall fitted housing according to claim 1, wherein the beading extends once around the circumference of the wall element under a predefined gradient.

4. The ceiling or wall fitted housing according to claim 1, wherein the beading is located in proximity to the supporting element.

5. The ceiling or wall fitted housing according to claim 1, wherein the fitted housing is made of a metal, preferably aluminum or stainless steel.

6. The ceiling or wall fitted housing according to claim 1, wherein the housing has a diameter of 50 to 600 mm, especially 70-450 mm.

7. The ceiling or wall fitted housing according to claim 1, wherein the fitted housing constitutes the lamp housing.

8. A manufacturing process for a ceiling or wall fitted housing, comprising the following steps:
production of a fitted housing, comprising a base element, a wall element linked to the base element, as well as a supporting element that is installed opposite to the base element and that extends from the wall element in the side that faces away from the base element, and
formation of a thread on the inside of the fitted housing through denting of a beading from the outside into the wall element with a predefined radial spin and vertical gradient.

9. The manufacturing process for a ceiling- or wall-fitted housing, according to claim 8, wherein the fitted housing is produced by means of reshaping processes, especially denting.

10. The manufacturing process for a ceiling- or wall-fitted housing, according to claim 8, wherein the beading is developed by performing a spin of a maximum of 360 degrees and under a predefined gradient.

11. The manufacturing process for a ceiling- or wall-fitted housing, according to claim 8, wherein the beading in the start and/or end section is formed with a gradually increasing and/or decreasing depth.

12. A wall or ceiling lamp, comprising a ceiling or wall fitted housing according to claim 1, further comprising an illuminant producing a source of light, and a translucent cover and/or insert that is equipped with a thread on an external wall side which can be meshed with the thread on the internal wall of the wall- or ceiling-fitted housing.
